(19) United States
(12) Patent Application Publication
(10) Pub. No.: US 2016/0120181 A1
(43) Pub. Date: May 5, 2016

(54) PHYSICALLY AND CHEMICALLY STABLE AGRICHEMICAL FORMULATIONS

(71) Applicants: Carolyn Estep MOORE, Greensboro, NC (US); SYNGENTA PARTICIPATIONS AG, Basel (CH)

(72) Inventor: Carolyn Estep MOORE, Greensboro, NC (US)

(73) Assignee: SYNGENTA PARTICIPATIONS AG, Basel (CH)

(21) Appl. No.: 14/890,276

(22) PCT Filed: May 8, 2014
(86) PCT No.: PCT/US2014/037356

§ 371 Date: Nov. 10, 2015

Related U.S. Application Data
(60) Provisional application No. 61/821,751, filed on May 10, 2013.

(51) Int. Cl. A01N 41/10

(52) U.S. Cl. CPC A01N 41/10

(57) ABSTRACT

Physically and chemically stable agrochemical compositions comprising cyclodextrin and mesotrione.

The present invention relates to stabilized, liquid, agrochemical compositions, the preparation of such compositions and a method of using such compositions to combat pests or as plant growth regulators.

Agriculturally active ingredients are often provided in the form of concentrates suitable for dilution with water. Many forms of agricultural concentrates are known and these consist of the active ingredient and a carrier, which can include various components. Water-based concentrates are obtained by dissolving, emulsifying and/or suspending agriculturally ac technical materials in water. Due to the relatively complex supply chain for crop protection agents, such concentrate formulations can be stored for long periods and may be subjected during storage and shipping to extreme temperature variations, high-shear and repetitive vibration patterns. Such supply chain conditions can increase the likelihood of formulation failure due to, for example, water mediated degradation and stability problems.

In some cases it may be desirable to combine different agrochemicals to provide a single formulation taking advantage of the additive properties of each separate agrochemical and optionally an adjuvant or combination of adjuvants that provide optimum biological performance. For example, transportation and storage costs can be minimized by using a formulation in which the concentration of the active agrochemical(s) is as high as is practicable and in which any desired adjuvants are “built-in” to the formulation as opposed to being separately tank-mixed. The higher the concentration of the active agrochemical(s) however, the greater is the probability that the stability of the formulation may be disturbed, or that one or more components may phase separate.

Another challenge arises where a user of an agrochemical liquid concentrate formulation dilutes the formulation in water (for example in a spray tank) to form a dilute aqueous spray composition. Such agrochemical spray compositions are widely used, but their performance sometimes can be limited by the tendency for certain agrochemicals to degrade in a spray tank on exposure to water. For example, agrochemical breakdown can increase with increasing alkalinity and water temperature, and with the length of time the spray composition is left in the tank.

In addition, it may be desirable to improve the effectiveness of the agrochemicals by controlling the release rate of agrochemical into the application site from the formulation. For agrochemicals that are to any significant extent soluble in water, this is a particular challenge if water is present in the formulation, because of the tendency of the agrochemical to come to thermodynamic equilibrium and partially dissolve within the formulation. To the extent that the agrochemical dissolves, this reduces the physical stability of the formulation and negates any controlled release properties.

In addition, spray tank mixes can contain a variety of chemicals and adjuvants that may interact and change the effectiveness of one or more of the agrochemicals included therein. Incompatibility, poor water quality and insufficient tank agitation can lead to reduced effectiveness of sprays, phytotoxicity and can affect equipment performance.

Considering the variety of conditions and special situations under which agrochemical liquid concentrate formulation are stored, shipped an used around the world, there remains a need for concentrate formulations of agrochemicals, including water sensitive agrochemicals, that provide stability benefits under at least some of those conditions and situations. There is a further need for such formulations having high loading that are stable when diluted with water under a wide range of field conditions.

The term cyclodextrin stands here for cyclic oligosaccharides formed from glucose molecules connected via α-1,4-glycoside bonds which can be obtained by enzymatic decomposition of starch. They comprise a Greek letter as prefix, depending on the number of glucose molecules from which they are built. α-, β-, γ- and δ-cyclodextrins with 6, 7, 8 or 9 glucose molecules are especially of importance.

The cyclodextrins according to the invention also include modified cyclodextrins. Modified cyclodextrins can in particular be obtained by modifying one or more of the primary and/or secondary hydroxyl groups as known in art.

Such cyclodextrins are generally known to a person skilled in the art and may in some cases also be available for sale. Mention may, for example, be made here of the cyclodextrins sold under the Cavamax® and Cavasol® brand names by Wacker Chemie AG, Germany.

Cyclodextrins exhibit a cavity through which they are able to entrap compounds. This property of cyclodextrins appears to be of importance for the use of cyclodextrins in the suspension concentrates according to the invention. In this sense, the size of the cavity influences the ability of a cyclodextrin to form an inclusion complex with a particular compound. In one embodiment of the present invention β-cyclodextrins are preferred.

The choice between a natural or modified cyclodextrin is less of importance according to the invention. Thus, it is up to a person skilled in the art to use either a natural or suitably modified cyclodextrin which meets the requirements for the ability to form an inclusion complex with a particular compound and also for the other properties, such as, for example, the solubility of the cyclodextrin.

This present technology comprises the use of cyclodextrin as a stabilizer for physical properties of complex suspoemulsion formulations. It is common knowledge to those skilled in the art that complex suspoemulsions having one or more non-water soluble liquid active ingredients and one or more solid active ingredients are difficult to formulate. These products are prone to serum separation, settling, lumping, and phase separation over the anticipated shelf-life of the product. Further, lack of physical stability may result in unsatisfactory product performance as well as cosmetic issues with customers.

Surprisingly, it has now been found that the addition of cyclodextrin to these complex formulation system resulted in a product with excellent physical stability, demonstrating no serum separation even at elevated temperatures for extended periods of time.

In a particularly preferred embodiment of the technology, it has been found that the a compositions comprising β-cyclodextrins and mesotrione acid results in composition that exhibit excellent physical and chemical stability and prevents the formation of a serum later that is typical when formulating with mesotrione acid. Those skilled in the art familiar with mesotrione understand that mesotrione is notoriously reactive and has a tendency to decompose in a variety of chemical and environmental conditions.

Mesotrione is a well know herbicide sold by Syngenta Crop Protection under the brand name Callisto®, among others. Mesotrione controls weed pests by inhibiting the plant enzyme 4-hydroxyphenylpyruvate dioxygenase (HPPD) and is most commonly used in controlling weeds in corn crops.

### EXAMPLE 1

| Component | CAS Number | Amount |
|---|---|---|
| β-cyclodextrin | 7585-39-9 | 100 g |
| Mesotrione acid | | 30 g |
| Water | | 100 g |

The β-cyclodextrin, mesotrione acid, and water were combined and gently heated to 50 degrees Celsius while being stirred. The mixture was allowed to cool to room temperature.

The present technology is also applicable to produce superior physically stable suspoemulsions. Suspoemulsions are known in the art and generally a combination of a suspension concentrate (SC) and concentrated emulsions (e.g. emulsifiable concentrate/emulsion in water (EC/EW)), where two active ingredients (e.g. pesticides) with very different physical properties can be combined into one formulation. A suspoemulsion generally consists of an organic phase with a dissolved active ingredient and an aqueous suspension phase, in which the active ingredient is dispersed in water.

Commercial available pesticides and their properties are general well known and descriptions can be found in numerous public resource, for example Compendium of Pesticide Common Names (<http://www.alanwood.net/pesticides/index.html>) or “The Pesticide Manual”, 16^{th} Ed. (2013), The British Crop Protection Council, London, United Kingdom (ISBN-13: 978-1901396867).

The present technology provides for superior physical and chemical stability when the present technology is utilized as the suspension concentrate portion in the suspoemulsions.

1. A composition comprising:
mesotrione acid; and
cyclodextrin.

2. The composition according to claim 1, wherein cyclodextrin is β-cyclodextrin.

3. A composition comprising:
an organic phase with at least one pesticidal active ingredient dissolved therein; and
an aqueous suspension phase comprising mesotrione acid and cyclodextrin.

4. The composition according to claim 3, wherein cyclodextrin is β-cyclodextrin.

5. The composition of claim 1, further comprising water.
